(19) United States
(12) Patent Application Publication
(10) Pub. No.: US 2013/0178569 A1
(43) Pub. Date: Jul. 11, 2013

(54) USE OF PRECIPITATED SILICA CONTAINING ALUMINIUM AND 3-ACRYLOXY-PROPYLTRIETHOXYSILANE IN AN ISOPRENIC ELASTOMER COMPOSITION

(71) Applicants: Laurent Guy, Rillieux-la-Pape (FR); Eric Perin, Villefranche-sur-Saonne (FR); Dominique Dupuis, Crepy-en-Valois (FR)

(72) Inventors: Laurent Guy, Rillieux-la-Pape (FR); Eric Perin, Villefranche-sur-Saonne (FR); Dominique Dupuis, Crepy-en-Valois (FR)

(73) Assignees: DOW CORNING CORPORATION, Midland, MI (US); RHODIA OPERATIONS, Aubervilliers (FR)

(21) Appl. No.: 13/638,861

(22) PCT Filed: Apr. 1, 2011
(86) PCT No.: PCT/EP2011/055141

§ 371 Date: Mar. 7, 2013

(30) Foreign Application Priority Data
Apr. 1, 2010 (FR) 10/01368
Nov. 3, 2010 (FR) 10 04309

(51) Int. Cl. C08K 3/36

(52) U.S. Cl. CPC C08K 3/36
USPC 524/444; 106/483

(57) ABSTRACT

The joint use in an elastomer composition of an isoprenic elastomer of a precipitated silica including aluminum as a reinforcing inorganic filler, in which the aluminum content of the precipitated silica is higher than 0.5 wt. %, and 3-acryloxy-propyltriethoxysilane as an inorganic filler, or an elastomer coupling agent is described. Also described, is an elastomer composition obtained therefrom and items produced from such a composition.

The invention relates to the joint use, in elastomer compositions comprising an isoprene elastomer, such as natural rubber, of a specific reinforcing inorganic filler and of a specific inorganic filler/elastomer coupling agent.

It also relates to the corresponding elastomer compositions and to the articles, in particular tires, comprising such compositions.

It is known that articles made of elastomer(s) are generally subjected to various stresses, for example such as a variation in temperature, a high frequency loading variation under dynamic conditions, a high static stress and/or a not insignificant flexural fatigue under dynamic conditions. Such articles are, for example, tires, footwear soles, floor coverings, conveyor belts, power transmission belts, flexible pipes, seals, in particular seals for domestic electrical appliances, supports which act to remove engine vibrations, either with metal frameworks or with a hydraulic fluid within the elastomer, cable sheathings, cables or rollers for cableways.

The proposal was then made to use in particular elastomer compositions reinforced by specific inorganic fillers described as “reinforcing”, preferably exhibiting a high dispersibility. These fillers, in particular white fillers, such as precipitated silicas, are capable of rivalling or even exceeding, at least from the reinforcing viewpoint, the carbon black conventionally employed and in addition offer these compositions a hysteresis which is generally lower, synonymous in particular with a decrease in the internal heating of the articles made of elastomer(s) during their use.

It is known to a person skilled in the art that it is generally necessary to employ, in the elastomer compositions comprising such reinforcing fillers, a coupling agent, also known as bonding agent, the role of which is in particular to provide the connection between the surface of the particles of inorganic filler (for example a precipitated silica) and the elastomer(s), while facilitating the dispersion of this inorganic filler within the elastomer matrix.

The term “inorganic filler/elastomer coupling agent” is understood to mean, in a known way, an agent capable of establishing a satisfactory connection, of chemical and/or physical nature, between the inorganic filler and the elastomer.

Such a coupling agent, which is at least bifunctional, has, for example, as simplified general formula, “N-V-M”, in which:
N represents a functional group (“N” functional group) capable of bonding physically and/or chemically to the inorganic filler, it being possible for such a bond to be established, for example, between a silicon atom of the coupling agent and the hydroxyl (OH) groups of the surface of the inorganic filler (for example surface silanols, when silica is concerned);
M represents a functional group (“M” functional group) capable of bonding physically and/or chemically to the elastomer, in particular via an appropriate atom or a group of appropriate atoms (for example a sulfur atom);
V represents a group (divalent/hydrocarbon group) which makes it possible to connect “N” and “M”.

The coupling agents must not be confused with simple covering agents for inorganic fillers which, in a known way, can comprise the “N” functional group active with regard to the inorganic filler but are devoid of the “M” functional group active with regard to the elastomer.

Coupling agents, in particular (silica/elastomer) coupling agents, have been described in many documents of the state of the art, the most well-known being silane (poly)sulfides, in particular alkoxysilane (poly)sulfides. Mention may in particular be made, among these silane (poly)sulfides, of bis(triethoxysilylpropyl) tetrasulfide (abbreviated to TESPT), which is generally still regarded today as a product contributing, for vulcanisates comprising an inorganic filler as reinforcing filler, such as silica, a very good, indeed even the best, compromise in terms of safety toward scorching, of ease of processing and of reinforcing power.

The combined use of precipitated silica, in particular highly dispersible silica, and of a silane (or functionalized organosilicon compound) polysulfide in a composition formed of modified elastomer(s) made possible the development of the “green tire” for passenger vehicles (light vehicles). This combination made it possible to achieve a wear resistance performance comparable to that of the mixtures of elastomers reinforced by carbon black, while significantly improving the rolling resistance (resulting in a fall in fuel consumption) and the wet grip.

It would therefore be advantageous to be able to also use an inorganic filler, such as silica, in tires for heavy vehicles, which tires are obtained from compositions based on isoprene elastomer(s), mainly natural rubber.

However, the same silica/silane polysulfide combination, applied to an isoprene elastomer, such as natural rubber, did not make it possible to obtain a satisfactory level of reinforcing (which may be illustrated by a stress/uniaxial tensile elongation curve) in comparison with that which is obtained when carbon black is used as filler, this poorer reinforcing resulting in a mediocre wear resistance.

The aim of the present invention is to provide in particular the association, for elastomer compositions comprising a diene elastomer, such as natural rubber, of a specific coupling agent with a specific reinforcing inorganic filler, this combination consisting of an alternative to the use of known coupling agents with known reinforcing inorganic fillers, this combination furthermore providing said elastomer compositions with a highly satisfactory compromise in properties, in particular with regard to their rheological, mechanical and/or dynamic properties, in particular hysteresis properties. Advantageously, it makes possible an improvement in the wear resistance and in the hysteresis/reinforcing compromise. In addition, the elastomer compositions obtained preferably exhibit a very good adhesion, both to the reinforcing inorganic filler employed and to the substrates to which they are subsequently applied.

The invention relates, in its first subject-matter, to the use, in an elastomer composition comprising at least one isoprene elastomer:

of an aluminum-comprising precipitated silica as reinforcing inorganic filler, the aluminum content of said precipitated silica being greater than 0.5% by weight, with

3-acryloxypropyltriethoxysilane (or γ-acryloxypropyltriethoxysilane) as inorganic filler/elastomer coupling agent.

Said precipitated silica used generally has an aluminum content of at most 7.0% by weight, preferably of at most 5.0% by weight, in particular of at most 3.5% by weight, for example of at most 3.0% by weight.

Preferably, its aluminum content is between 0.75 and 4.0% by weight, more preferably still between 0.8 and 3.5% by weight, in particular between 0.9 and 3.2% by weight, especially between 0.9 and 2.5% by weight or between 1.0 and 3.1% by weight. It is, for example, between 1.0 and 3.0% by weight, indeed even between 1.0 and 2.0% by weight.

The amount of aluminum can be measured by any suitable method, for example, by ICP-AES (“Inductively Coupled Plasma-Atomic Emission Spectroscopy”) after dissolving in water in the presence of hydrofluoric acid.

The aluminum is generally located essentially at the surface of the precipitated silica.

Even if the aluminum can be present simultaneously in the tetrahedral form, in the octahedral form and in the pentahedral form, in particular in the tetrahedral form and in the octahedral form, in the precipitated silica used in the invention, it is preferably essentially in the tetrahedral form (more than 50% by number, in particular at least 90% by number, especially at least 95% by number, of the aluminum entities are then in tetrahedral form); the bonds are then instead essentially of the SiOAl type.

Said aluminum-comprising precipitated silica employed in the invention is advantageously highly dispersible, that is to say that, in particular, it exhibits a very great ability to deagglomerate and disperse in a polymer matrix, which can be observed in particular by electron or optical microscopy on thin sections.

Preferably, the precipitated silica used according to the invention has a CTAB specific surface of between 70 and 240 m²/g.

This can be between 70 and 100 m²/g, for example between 75 and 95 m²/g.

However, very preferably, its CTAB specific surface is between 100 and 240 m²/g, in particular between 140 and 200 m²/g.

Likewise, preferably, the precipitated silica used according to the invention has a BET specific surface of between 70 and 240 m²/g.

This can be between 70 and 100 m²/g, for example between 75 and 95 m2/g.

However, very preferably, its BET specific surface is between 100 and 240 m²/g, in particular between 140 and 200 m²/g.

The CTAB specific surface is the external surface, which can be determined according to the NF T 45007 method (November 1987). The BET specific surface can be measured according to the BRUNAUER-EMMETT-TELLER method described in “The Journal of the American Chemical Society”, vol. 60, page 309 (1938) and corresponding to the standard NF T 45007 (November 1987).

The ability to disperse (and to deagglomerate) of the precipitated silica employed according to the invention can be assessed by means of the following test, by a particle size measurement (by laser diffraction) carried out on a suspension of silica deagglomerated beforehand using ultrasound (cleavage of the objects from 0.1 to a few tens of microns). The deagglomeration under ultrasound is carried out using a VIBRACELL BIOBLOCK (750 W) sonicator equipped with a probe with a diameter of 19 mm. The particle size measurement is carried out by laser diffraction on a SYMPATEC particle sizer employing the Fraunhofer theory.

2 grams of silica are weighed into a sample tube (height: 6 cm and diameter: 4 cm) and the mixture is made up to 50 grams by the addition of deionized water: an aqueous 4% silica suspension is thus produced, which suspension is homogenized by magnetic stirring for 2 minutes. Deagglomeration under ultrasound is subsequently carried out as follows: the probe being immersed over a length of 4 cm, it is set going for 5 minutes and 30 seconds at 80% of its nominal power (amplitude). The particle size measurement is subsequently carried out by introducing, into the vessel of the particle sizer, a volume V (expressed in ml) of the homogenized suspension necessary in order to obtain an optical density of the order of 20.

The value of the median diameter Ø₅₀ which is obtained according to this test decreases in proportion as the ability of the silica to deagglomerate increases.

A deagglomeration factor F_{D} is given by the equation:

F_{D}=10×V/optical density of the suspension measured by the particle sizer (this optical density is of the order of 20).

This deagglomeration factor F_{D} is indicative of the content of particles with a size of less than 0.1 μm which are not detected by the particle sizer. This factor increases in proportion as the ability of the silica to deagglomerate increases.

In general, the precipitated silica comprising the aluminum employed according to the invention has a median diameter Ø₅₀, after deagglomeration under ultrasound, of less than 5 μm, in particular of less than 4 μm, especially of less than 3.5 μm, for example of less than 3 μm.

It usually exhibits an ultrasound deagglomeration factor F_{D} of greater than 4.5 ml, in particular of greater than 5.5 ml, especially of greater than 9 ml, for example of greater than 10 ml.

The DOP oil uptake of the aluminum-comprising precipitated silica employed according to the invention can be less than 300 ml/100 g, for example between 200 and 295 ml/100 g. The DOP oil uptake can be determined according to the standard ISO 787/5 by employing dioctyl phthalate.

One of the parameters of the precipitated silica employed in the invention can lie in the distribution of its pore volume and in particular in the distribution of the pore volume which is generated by the pores having diameters of less than or equal to 400 Å. The latter volume corresponds to the useful pore volume of the fillers employed in reinforcing the elastomers.

While this precipited silica can have, according to a first alternative form, a pore distribution (and this can be illustrated by the analysis of the porograms) such that the pore volume generated by the pores having a diameter of between 175 and 275 Å (V2) represents less than 50% of the pore volume generated by the pores having diameters of less than or equal to 400 Å (V1), it can also be advantageous to employ, according to a second alternative form, a precipitated silica having a pore distribution such that the pore volume generated by the pores having a diameter of between 175 and 275 Å (V2) represents at least 50% (for example between 50 and 60%) of the pore volume generated by the pores having diameters of less than or equal to 400 Å (V1).

The pore volumes and pore diameters are measured by mercury (Hg) porosimetry using a MICROMERITICS Autopore 9520 porosimeter and are calculated by the WASHBURN relationship with a contact angle theta equal to 130° and a surface tension gamma equal to 484 Dynes/cm (standard DIN 66133).

The pH of the precipitated silica used according to the invention is generally between 6.3 and 8.0, for example between 6.3 and 7.6.

The pH is measured according to the following method deriving from the standard ISO 787/9 (pH of a 5% suspension in water): Equipment:
calibrated pH meter (accuracy of reading to 1/100th)
combined glass electrode
200 ml beaker
100 ml measuring cylinder
balance accurate to 0.01 gram.

Procedure:

5 grams of silica are weighed to within 0.01 gram into the 200 ml beaker. 95 ml of water, measured from the graduated measuring cylinder, are subsequently added to the silica powder. The suspension thus obtained is vigorously stirred (magnetic stirring) for 10 minutes. The pH measurement is then carried out.

The precipitated silica to be used according to the invention can be provided in any physical state, that is to say that it can be provided, for example, in the form of microbeads (substantially spherical beads), powders or granules.

It can thus be provided in the form of substantially spherical beads with a mean size of at least 80 μm, preferably of at least 150 μm, in particular of between 150 and 270 μm; this mean size is determined according to the standard NF X 11507 (December 1970) by dry sieving and determination of the diameter corresponding to a cumulative oversize of 50%.

It can be provided in the form of a powder with a mean size of at least 3 μm, in particular of at least 10 μm, preferably of at least 15 μm.

It can be provided in the form of granules (generally of substantially parallelepipedal shape) with a size of at least 1 mm, for example of between 1 and 10 mm, in particular along the axis of their greatest dimension (length).

According to a nonlimiting specific alternative form, the precipitated silica having an aluminum content of greater than 0.5% by weight used according to the invention can exhibit:
a CTAB specific surface of between 140 and 200 m²/g,
a BET specific surface of between 140 and 200 m²/g,
optionally a DOP oil uptake of less than 300 ml/100 g,
a median diameter Ø₅₀, after ultrasound deagglomeration, of less than 3 μm, and
an ultrasound deagglomeration factor F_{D} of greater than 10 ml.

In this specific alternative form, the precipitated silica can, for example, exhibit a pore distribution such that the pore volume generated by the pores having a diameter of between 175 and 275 Å (V2) represents at least 50%, for example between 50 and 60%, of the pore volume generated by the pores with diameters of less than or equal to 400 Å (V1).

According to another nonlimiting specific alternative form, the precipitated silica having an aluminum content of greater than 0.5% by weight used according to the invention can exhibit:
a CTAB specific surface of between 140 and 200 m²/g,
optionally a DOP oil uptake of less than 300 ml/100 g,
a pore distribution such that the pore volume composed of the pores having a diameter of between 175 and 275 Å (V2) represents less than 50% of the pore volume composed of the pores with diameters of less than or equal to 400 Å (V1), and
a median diameter Ø₅₀, after ultrasound deagglomeration, of less than 5 μm.

According to another nonlimiting specific alternative form, the precipitated silica having an aluminum content of greater than 0.5% by weight used according to the invention can exhibit:
a CTAB specific surface of between 140 and 200 m²/g,
optionally a DOP oil uptake of less than 300 ml/100 g,
a pore distribution such that the pore volume composed of the pores having a diameter of between 175 and 275 Å (V2) represents at least 50%, for example between 50 and 60%, of the pore volume composed of the pores with diameters of less than or equal to 400 Å (V1), and
a median diameter Ø₅₀, after ultrasound deagglomeration, of less than 5 μm.

The precipitated silica employed in the context of the invention can be prepared, for example, by a process as described in patent applications EP-A-0 762 992, EP-A-0 762 993, EP-A-0 983 966 and EP-A-1 355 856.

Preferably, the precipitated silica employed in the invention can be obtained by a preparation process comprising the precipitation reaction between a silicate and an acidifying agent, whereby a suspension of precipitated silica is obtained, and then the separation and the drying of this suspension, in which:

the precipitation reaction is carried out in the following way:
(i) an initial vessel heel comprising a silicate and an electrolyte is formed, the concentration of silicate (expressed as SiO₂) in said initial vessel heel being less than 100 g/l and the concentration of electrolyte in said initial vessel heel being less than 17 g/l,
(ii) the acidifying agent is added to said vessel heel until a value for the pH of the reaction medium of at least 7 is obtained,
(iii) acidifying agent and a silicate are added simultaneously to the reaction medium,

a suspension exhibiting a solids content of at most 24% by weight is dried, said process comprising one of the three following operations (a), (b) or (c):
(a) at least one aluminum compound A and, subsequently or simultaneously, a basic agent are added to the reaction medium, after stage (iii),
(b) a silicate and at least one aluminum compound A are added simultaneously to the reaction medium, after stage (iii) or in place of stage (iii),
(c) stage (iii) is carried out by simultaneously adding, to the reaction medium, acidifying agent, a silicate and at least one aluminum compound B.

It should be noted, generally, that this preparation process is a process for the synthesis of precipitated silica, that is to say that an acidifying agent is reacted with a silicate under specific conditions.

The choice of the acidifying agent and of the silicate is made in a way well known per se.

Use is generally made, as acidifying agent, of a strong inorganic acid, such as sulfuric acid, nitric acid or hydrochloric acid, or of an organic acid, such as acetic acid, formic acid or carbonic acid.

The acidifying agent can be dilute or concentrated; its normality can be between 0.4 and 36N, for example between 0.6 and 1.5N.

In particular, in the case where the acidifying agent is sulfuric acid, its concentration can be between 40 and 180 g/l, for example between 60 and 130 g/l.

Use may furthermore be made, as silicate, of any common form of silicates, such as metasilicates, disilicates and advantageously an alkali metal silicate, in particular sodium or potassium silicate.

The silicate can exhibit a concentration (expressed as SiO₂) of between 40 and 330 g/l, for example between 60 and 300 g/l.

Generally, use is made, as acidifying agent, of sulfuric acid and, as silicate, of sodium silicate.

In the case where use is made of sodium silicate, the latter generally exhibits an SiO₂/Na₂O ratio by weight of between 2.5 and 4, for example between 3.1 and 3.8.

The reaction of the silicate with the acidifying agent is carried out specifically according to the following stages.

First of all, a vessel heel is formed which comprises silicate and an electrolyte (stage (i)). The amount of silicate present in the initial vessel heel advantageously represents only a portion of the total amount of silicate involved in the reaction.

The term “electrolyte” is understood here as normally accepted, that is to say that it means any ionic or molecular substance which, when it is in solution, decomposes or dissociates to form ions or charged particles. Mention may be made, as electrolytes, of a salt from the group of the salts of alkali metals and alkaline earth metals, in particular the salt of the metal of the starting silicate and of the acidifying agent, for example sodium chloride in the case of the reaction of a sodium silicate with hydrochloric acid or, preferably, sodium sulfate in the case of the reaction of a sodium silicate with sulfuric acid.

The concentration of electrolyte in the initial vessel heel is (greater than 0 g/l and) less than 17 g/l, for example less than 14 g/l.

The concentration of silicate (expressed as SiO₂) in the initial vessel heel is (greater than 0 g/l and) less than 100 g/l; preferably, this concentration is less than 90 g/l, in particular less than 85 g/l.

The second stage consists in adding the acidifying agent to the composition vessel heel described above (stage (ii)).

This addition, which results in a correlative fall in the pH of the reaction medium, is carried out until a pH value of at least 7, generally of between 7 and 8, is reached.

Once the desired pH value is reached, a simultaneous addition (stage (iii)) of acidifying agent and silicate is then carried out.

This simultaneous addition is generally carried out in such a way that the pH value of the reaction medium is always equal (to within +/−0.1) to that reached on conclusion of stage (ii).

This preparation process comprises one of the three operations (a), (b) and (c) mentioned above, that is to say:

(a) at least one aluminum compound A and, subsequently or simultaneously, a basic agent are added, after stage (iii), to the reaction medium, the separation carried out in the process preferably comprising a filtration and a disintegrating of the cake resulting from this filtration, said disintegrating then preferably being carried out in the presence of at least one aluminum compound B,

(b) a silicate and at least one aluminum compound A are simultaneously added, after stage (iii) or in place of stage (iii), to the reaction medium, the separation carried out in the process preferably comprising a filtration and a disintegrating of the cake resulting from this filtration, said disintegrating then preferably being carried out in the presence of at least one aluminum compound B, or

(c) acidifying agent, a silicate and at least one aluminum compound B are simultaneously added, during stage (iii), to the reaction medium, the separation carried out in the process preferably comprising a filtration and a disintegrating of the cake resulting from this filtration, the disintegrating then optionally being carried out in the presence of at least one aluminum compound B.

In a first alternative form of this preparation process (that is to say, when the latter comprises the operation (a)), the following stages are advantageously carried out, after having carried out the precipitation according to stages (i), (ii) and (iii) described above:

(iv) at least one aluminum compound A is added to the reaction medium (that is to say, the reaction suspension or slurry obtained),

(v) a basic agent is added to the reaction medium, preferably until a pH value of the reaction medium of between 6.5 and 10, in particular between 7.2 and 8.6, is obtained, then

(vi) acidifying agent is added to the reaction medium, preferably until a pH value of the reaction medium of between 3 and 5, in particular between 3.4 and 4.5, is obtained.

Stage (v) can be carried out simultaneously or, preferably, after stage (iv).

A maturing of the reaction medium can be carried out after the simultaneous addition of stage (iii), it being possible for this maturing to last, for example, from 1 to 60 minutes, in particular from 3 to 30 minutes.

In this first alternative form, it may be desirable, between stage (iii) and stage (iv), and in particular before said optional maturing, to add an additional amount of acidifying agent to the reaction medium. This addition is generally carried out until a pH value of the reaction medium of between 3 and 6.5, in particular between 4 and 6, is obtained.

The acidifying agent used during this addition is generally identical to that employed during stages (ii), (iii) and (vi) of the first alternative form of the process.

A maturing of the reaction medium is usually carried out between stage (v) and stage (vi), for example for 2 to 60 minutes, in particular for 5 to 45 minutes.

Likewise, a maturing of the reaction medium is generally carried out after stage (vi), for example for 2 to 60 minutes, in particular for 5 to 30 minutes.

The basic agent used during stage (v) can be an aqueous ammonia solution or, preferably, a sodium hydroxide solution.

In a second alternative form of said process (that is to say, when the latter comprises the operation (b)), a stage (iv) is carried out, after stages (i), (ii) and (iii) described above or in place of stage (iii) described above, which consists in simultaneously adding, to the reaction medium, a silicate and at least one aluminum compound A.

Only in the case where the aluminum compound A is sufficiently acidic (for example, this can be the case when this compound A is an aluminum sulfate) is it in fact possible (but not obligatory) to replace stage (iii) by stage (iv), which means in fact that stage (iii) and stage (iv) then form only a single stage, the aluminum compound A then acting as acidifying agent.

The simultaneous addition of stage (iv) is generally carried out in such a way that the pH value of the reaction medium is always equal (to within +/−0.1) to that reached on conclusion of stage (iii) or of stage (ii).

A maturing of the reaction medium can be carried out after the simultaneous addition of stage (iv), it being possible for this maturing to last, for example, from 2 to 60 minutes, in particular from 5 to 30 minutes.

In this second alternative form, it may be desirable, after stage (iv), and in particular after this optional maturing, to add an additional amount of acidifying agent to the reaction medium. This addition is generally carried out until a pH value of the reaction medium of between 3 and 6.5, in particular between 4 and 6, is obtained.

The acidifying agent used during this addition is generally identical to that employed during stage (ii) of the second alternative form of the process.

A maturing of the reaction medium is usually carried out after this addition of acidifying agent, for example for 1 to 60 minutes, in particular for 3 to 30 minutes.

The aluminum compound A employed in the preparation process (in particular in the first two alternative forms mentioned) is generally an organic or inorganic aluminum salt.

Mention may in particular been made, as examples of organic salt, of salts of carboxylic or polycarboxylic acids, such as salts of acetic, citric, tartaric or oxalic acid.

Mention may in particular be made, as examples of inorganic salt, of halides and oxyhalides (such as chlorides or oxychlorides), nitrates, phosphates, sulfates and oxysulfates.

In practice, the aluminum compound A can be used in the form of a solution, generally an aqueous solution.

Preferably, use is made, as aluminum compound A, of an aluminum sulfate.

In a third alternative form of this preparation process (that is to say, when the latter comprises the operation (c)), a stage (iii) is advantageously carried out, after having carried out stages (i) and (ii) described above, which consists in simultaneously adding, to the reaction medium, acidifying agent, a silicate and at least one aluminum compound B.

This simultaneous addition is generally carried out in such a way that the pH value of the reaction medium is always equal (to within +/−0.1) to that reached on conclusion of stage (ii).

In this third alternative form, it may be desirable, after stage (iii), to add an additional amount of acidifying agent to the reaction medium. This addition is generally carried out until a pH value of the reaction medium of between 3 and 6.9, in particular between 4 and 6.6, is obtained.

The acidifying agent used during this addition is generally identical to that employed during stages (ii) and (iii).

A maturing of the reaction medium is usually carried out after this addition of acidifying agent, for example for 1 to 60 minutes, in particular for 3 to 30 minutes.

The aluminum compound B employed in the third alternative form is generally an alkali metal aluminate, in particular potassium aluminate or preferably sodium aluminate.

The temperature of the reaction medium is generally between 75 and 98° C.

According to an alternative form, the reaction is carried out at a constant temperature between 75 and 96° C.

According to another (preferred) alternative form, the temperature at the end of the reaction is higher than the temperature at the start of the reaction: thus, the temperature at the start of the reaction is preferably maintained between 70 and 96° C. and then the temperature is increased in a few minutes preferably up to a value of between 80 and 98° C., at which value it is maintained until the end of the reaction; the operations (a) or (b) are thus usually carried out at this constant temperature value.

On conclusion of the stages which have just been described, a silica slurry is obtained, which slurry is subsequently separated (liquid/solid separation).

In general, this separation comprises a filtration (followed, if necessary, by a washing operation) and a disintegrating, it being possible for said disintegrating to then be carried out (preferably in the case of the first two alternative forms mentioned, optionally in the case of the third alternative form) in the presence of at least one aluminum compound B and optionally in the presence of an acidifying agent as described above (in the latter case, the aluminum compound B and the acidifying agent are advantageously added simultaneously).

The disintegrating operation, which can be carried out mechanically, for example by passing the filtration cake through a mill of colloid or bead type, makes it possible in particular to lower the viscosity of the suspension to be dried (in particular to be sprayed) subsequently.

The aluminum compound B is usually different from the aluminum compound A mentioned above and consists generally of an alkali metal aluminate, in particular potassium aluminate or preferably sodium aluminate.

The amounts of aluminum compounds A and B used in this preparation process are such that the precipitated silica obtained has more than 0.5% by weight of aluminum, and in particular a preferred amount of aluminum as mentioned above.

The separation employed in this process normally comprises a filtration (with, if necessary, a washing operation) carried out by means of any suitable method, for example by means of a belt filter, a vacuum filter or, preferably, a filter press.

The suspension of precipitated silica thus recovered (filtration cake) is subsequently dried.

In this preparation process, this suspension must exhibit, immediately before it is dried, a solids content of at most 24% by weight, preferably of at most 22% by weight.

This drying operation can be carried out according to any means known per se.

Preferably, the drying operation is carried out by atomization. To this end, use may be made of any type of suitable atomizer, in particular a rotary, nozzle, liquid pressure or two-fluid atomizer. In general, when the filtration is carried out using a filter press, a nozzle atomizer is used and, when the filtration is carried out using a vacuum filter, a rotary atomizer is used.

When the drying operation is carried out using a nozzle atomizer, the precipitated silica capable of then being obtained usually exists in the form of substantially spherical beads.

On conclusion of this drying operation, it is optionally possible to carry out a milling stage on the product recovered; the precipitated silica capable of then being obtained generally exists in the form of a powder.

When the drying operation is carried out using a rotary atomizer, the precipitated silica capable of then being obtained can exist in the form of a powder.

Finally, the dried (in particular by a rotary atomizer) or milled product as indicated above can optionally be subjected to an agglomeration stage, which consists, for example, of a direct compression, a wet granulation (that is to say, with use of a binder, such as water, silica suspension, and the like), an extrusion or, preferably, a dry compacting. When the latter technique is employed, it can prove to be opportune, before carrying out the compacting, to deaerate (operation also referred to as predensifying or degassing) the pulverulent products so as to remove the air included in the latter and to provide more uniform compacting.

The precipitated silica capable of then being obtained by this agglomeration stage generally exists in the form of granules.

The 3-acryloxypropyltriethoxysilane (or γ-acryloxypropyltriethoxysilane) employed in the invention as inorganic filler/elastomer coupling agent can be prepared from allyl acrylate and triethoxysilane by a process as described in U.S. Pat. No. 3,179,612.

The aluminum-comprising precipitated silica used according to the present invention as reinforcing inorganic filler and the 3-acryloxypropyltriethoxysilane used according to the present invention as reinforcing inorganic filler/elastomer coupling agent can be mixed together prior to the use thereof. A first alternative form consists in the 3-acryloxypropyltriethoxysilane not being grafted to said precipitated silica; a second alternative form consists in the 3-acryloxypropyltriethoxysilane being grafted to said precipitated silica, which will thus be “precoupled” before it is mixed with the elastomer composition.

It is possible to employ all or part of the 3-acryloxypropyltriethoxysilane used according to the invention as coupling agent in the form supported (placing on a support being carried out prior to the use thereof) on a solid compatible with its chemical structure, it being possible for this solid support to be, for example, carbon black or, preferably, aluminum-comprising precipitated silica used according to the present invention.

The elastomer compositions in which the 3-acryloxypropyltriethoxysilane is employed according to the invention can comprise at least one covering agent for the precipitated silica used as reinforcing filler. This covering agent is capable, in a known way, of improving the processability of the elastomer compositions in the raw state.

Such a covering agent can consist, for example, of an alkylalkoxysilane (in particular an alkyltriethoxysilane), a polyol, a polyether (in particular a polyethylene glycol), a polyetheramine, a primary, secondary or tertiary amine (in particular a trialkanolamine), an α,ω-dihydroxylated polydimethylsiloxane or an α,ω-diaminated polydimethylsiloxane.

This covering agent can optionally be mixed with said precipitated silica and the 3-acryloxypropyltriethoxysilane prior to the use thereof.

The elastomer compositions in which the 3-acryloxypropyltriethoxysilane and the precipitated silica described above are used according to the invention can optionally comprise at least one other inorganic filler/elastomer coupling agent, in particular a silane sulfide or polysulfide.

Mention may be made, as examples of such a coupling agent, of:

bis(triethoxysilylpropyl) disulfide (abbreviated to TESPD) of formula:

(C₂H_{S}O)₃Si—(CH₂)₃—S₂—(CH₂)₃—Si(OC₂H₅)₃

bis(triethoxysilylpropyl) tetrasulfide (abbreviated to TESPT) of formula:

(C₂H_{S}O)₃—Si—(CH₂)₃—S₄—(CH₂)₃—Si(OC₂H₅)₃

bis(monohydroxydimethylsilylpropyl) tetrasulfide of formula:

(HO)(CH₃)₂Si—(CH₂)₃—S₄—(CH₂)₃—Si(CH₃)₂(OH)

bis(monoethoxydimethylsilylpropyl) disulfide (abbreviated to MESPD) of formula:

(C₂H_{S}O)(CH₃)₂Si—(CH₂)₃—S₂—(CH₂)₃—Si(CH₃)₂(OC₂H₅)

bis(monoethoxydimethylsilylpropyl) tetrasulfide (abbreviated to MESPT) of formula:

(C₂H_{S}O)(CH₃)₂Si—(CH₂)₃—S₄—(CH₂)₃—Si(CH₃)₂(OC₂H₅)

bis(monoethoxydimethylsilylisopropyl) tetrasulfide (abbreviated to MESiPrT) of formula:

(C₂H_{S}O)(CH₃)₂Si—CH₂—CH—(CH₃)—S₄—(CH₃)—CH—CH₂—Si(CH₃)₂(OC₂H₅)

However, in a preferred manner, said elastomer compositions do not comprise an inorganic filler/elastomer coupling agent other than 3-acryloxypropyltriethoxysilane.

The use according to the invention can optionally be carried out in the presence of a free radical initiator (for example from 0.02 to 5% by weight, in particular from 0.05 to 0.5% by weight, with respect to the amount by weight of elastomer(s)), that is to say of a compound (in particular an organic compound) capable, in particular subsequent to an energy activation, of generating free radicals in situ, in its surrounding medium, in this instance in the elastomer(s). The free radical initiator is then here an initiator of the thermal initiation type, that is to say that the contribution of energy, for the creation of free radicals, is made in the thermal form. Its decomposition temperature should generally be less than 180° C., in particular less than 160° C.

It is, for example, selected from the group consisting of organic peroxides, organic hydroperoxides, azido compounds, bis(azo) compounds, peracids, peresters or a mixture of at least two of these compounds. It is in particular an organic peroxide, for example benzoyl peroxide, acetyl peroxide, lauryl peroxide or 1,1-bis(t-butyl)-3,3,5-trimethylcyclohexyl peroxide, the peroxide optionally being placed on a solid support, such as calcium carbonate.

However, preferably, the invention is implemented in the absence of any free radical initiator.

The elastomer composition employed in the invention may advantageously not comprise elastomers other than the isoprene elastomer(s) which it comprises.

It can optionally (non-preferred alternative form) comprise at least one elastomer other than an isoprene elastomer. In particular, it can optionally comprise at least one isoprene elastomer (for example natural rubber) and at least one diene elastomer other than an isoprene elastomer, the amount of isoprene elastomer(s) with respect to the total amount of elastomer(s) then preferably being greater than 50% by weight (generally less than 99.5% by weight and, for example, between 70 and 99% by weight).

The elastomer composition employed according to the invention generally comprises at least one isoprene elastomer (natural or synthetic) selected from:
(1) synthetic polyisoprenes obtained by homopolymerization of isoprene or 2-methyl-1,3-butadiene;
(2) synthetic polyisoprenes obtained by copolymerization of isoprene with one or more ethylenically unsaturated monomers selected from:

(2.1) conjugated diene monomers, other than isoprene, having from 4 to 22 carbon atoms, such as, for example, 1,3-butadiene, 2,3-dimethyl-1,3-butadiene, 2-chloro-1,3-butadiene (or chloroprene), 1-phenyl-1,3-butadiene, 1,3-pentadiene or 2,4-hexadiene;

(2.2) vinylaromatic monomers having from 8 to 20 carbon atoms, such as, for example, styrene, ortho-, meta- or para-methylstyrene, the commercial mixture “vinyltoluene”, para-(tert-butyl)styrene, methoxystyrenes, chlorostyrenes, vinylmesitylene, divinylbenzene or vinylnaphthalene;

(2.3) vinyl nitrile monomers having from 3 to 12 carbon atoms, such as, for example, acrylonitrile or methacrylonitrile;

(2.4) acrylic ester monomers derived from acrylic acid or methacrylic acid with alkanols having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate;

(2.5) a mixture of at least two of the abovementioned monomers (2.1) to (2.4); copolymeric polyisoprenes comprising between 20 and 99% by weight of isoprene units and between 80 and 1% by weight of diene, vinylaromatic, vinyl nitrile and/or acrylic ester units, and consisting, for example, of poly(isoprene/butadiene), poly(isoprene/styrene) and poly(isoprene/butadiene/styrene);
(3) natural rubber;
(4) the copolymers obtained by copolymerization of isobutene and isoprene, and also the halogenated versions, in particular chlorinated or brominated versions, of these copolymers;
(5) a mixture of at least two of the abovementioned elastomers (1) to (4);
(6) a mixture comprising more than 50% by weight (preferably less than 99.5% by weight and for example between 70 and 99% by weight) of abovementioned elastomer (1) or (3) and less than 50% by weight (preferably more than 0.5% by weight and for example between 1 and 30% by weight) of one or more diene elastomers other than isoprene elastomers.

The term “diene elastomer other than an isoprene elastomer” is understood to mean, in a way known per se, in particular: the homopolymers obtained by polymerization of one of the conjugated diene monomers defined above in point (2.1), such as, for example, polybutadiene and polychloroprene; the copolymers obtained by copolymerization of at least two of the abovementioned conjugated dienes (2.1) with one another or by copolymerization of one or more of the abovementioned conjugated dienes (2.1) with one or more abovementioned unsaturated monomers (2.2), (2.3) and/or (2.4), such as, for example, poly(butadiene/styrene) and poly(butadiene/acrylonitrile); the ternary copolymers obtained by copolymerization of ethylene and an a-olefin having from 3 to 6 carbon atoms with a nonconjugated diene monomer having from 6 to 12 carbon atoms, such as, for example, the elastomers obtained from ethylene and propylene with a nonconjugated diene monomer of the abovementioned type, such as in particular 1,4-hexadiene, ethylidenenorbornene or dicyclopentadiene (EPDM elastomer).

Preferably, the elastomer composition comprises at least one isoprene elastomer selected from:
(1) homopolymeric synthetic polyisoprenes;
(2) copolymeric synthetic polyisoprenes consisting of poly(isoprene/butadiene), poly(isoprene/styrene) and poly(isoprene/butadiene/styrene);
(3) natural rubber;
(4) butyl rubber;
(5) a mixture of at least two of the abovementioned elastomers (1) to (4);
(6) a mixture comprising more than 50% by weight (preferably less than 99.5% by weight and for example between 70 and 99% by weight) of abovementioned elastomer (1) or (3) and less than 50% by weight (preferably more than 0.5% by weight and for example between 1 and 30% by weight) of diene elastomer other than an isoprene elastomer consisting of polybutadiene, polychloroprene, poly(butadiene/styrene), poly(butadiene/acrylonitrile) or an (ethylene/propylene/nonconjugated diene monomer) terpolymer.

More preferably, the elastomer composition comprises at least one isoprene elastomer selected from: (1) homopolymeric synthetic polyisoprenes; (3) natural rubber; (5) a mixture of the abovementioned elastomers (1) and (3); (6) a mixture comprising more than 50% by weight (preferably less than 99.5% by weight and for example between 70 and 99% by weight) of abovementioned elastomer (1) or (3) and less than 50% by weight (preferably more than 0.5% by weight and for example between 1 and 30% by weight) of diene elastomer other than an isoprene elastomer consisting of polybutadiene or poly(butadiene/styrene).

According to a highly preferred alternative form of the invention, the elastomer composition comprises, as isoprene elastomer, at least natural rubber, indeed even solely natural rubber.

According to an even more preferred alternative form, the elastomer composition comprises, as elastomer(s), solely natural rubber.

Generally, the elastomer composition employed according to the invention additionally comprises all or some of the other constituents and auxiliary additives normally employed in the field of elastomeric compositions.

Thus, generally, it comprises at least one compound selected from vulcanization agents (for example sulfur or a sulfur-donating compound (such as a thiuram derivative)), vulcanization accelerators (for example a guanidine derivative or a thiazole derivative), vulcanization activators (for example stearic acid, zinc stearate and zinc oxide, which can optionally be introduced in a fractional manner during the preparation of the composition), carbon black, protecting agents (in particular antioxidants and/or antiozonants, such as, for example, N-phenyl-N′-(1,3-dimethylbutyl)-p-phenylenediamine), antireversion agents (such as, for example, hexamethylene-1,6-bis(thiosulfate) or 1,3-bis(citraconimidomethyl)benzene) or plasticizing agents.

The joint use according to the invention of the aluminum-comprising precipitated silica described in the above account and of 3-acryloxypropyltriethoxysilane can be carried out more particularly in footwear soles, floor coverings, gas barriers, flame-retardant materials, rollers for cableways, seals for domestic electrical appliances, seals for liquid or gas pipes, braking system seals, pipes (flexible), sheathings (in particular cable sheathings), cables, engine supports, conveyor belts, transmission belts or, preferably, tires (in particular tire treads), advantageously in tires for heavy vehicles, in particular for trucks.

The elastomer composition obtained according to the use in accordance with the invention comprises an effective amount of 3-acryloxypropyltriethoxysilane.

More particularly, the elastomer compositions resulting from the invention can comprise (parts by weight), per 100 parts of isoprene elastomer(s):

10 to 200 parts, in particular 20 to 150 parts, especially 30 to 110 parts, for example 30 to 75 parts, of aluminum-comprising precipitated silica as described above and used as reinforcing inorganic filler;

1 to 20 parts, in particular 2 to 20 parts, especially 2 to 12 parts, for example 2 to parts, of 3-acryloxypropyltriethoxysilane used as reinforcing inorganic filler/elastomer coupling agent. Preferably, the amount of 3-acryloxypropyltriethoxysilane used, selected in particular from the abovementioned ranges, is determined so that it generally represents from 1 to 20% by weight, in particular from 2 to 15% by weight, for example from 4 to 12% by weight, with respect to the amount used of aluminum-comprising precipitated silica as described above.

In general, the total amounts of coupling agents+optional covering agent are identical to those mentioned above when use is made, in addition to the coupling agent (3-acryloxypropyltriethoxysilane) used according to the invention, of another coupling agent (in particular sulfide or polysulfide) and/or of a covering agent.

A second subject-matter of the present invention is the elastomer compositions described above and thus comprising:

at least one isoprene elastomer,

at least one reinforcing inorganic filler,

at least one inorganic filler/elastomer coupling agent,

characterized in that said reinforcing inorganic filler and said inorganic filler/elastomer coupling agent are as defined above according to the first subject-matter of the invention, that is to say that said reinforcing inorganic filler is the aluminum-comprising precipitated silica as described in the above account and said inorganic filler/elastomer coupling agent is 3-acryloxypropyltriethoxysilane.

Everything which was described above in the context of the use according to the first subject-matter of the invention applies to these elastomer compositions.

The elastomer compositions according to the invention can be prepared according to any conventional two-phase procedure. A first phase (“nonproductive” phase) is a phase of high-temperature thermomechanical working. It is followed by a second phase of mechanical working (“productive” phase) at temperatures generally of less than 110° C., in which the vulcanization system is introduced.

The invention, taken in its second subject-matter, relates to elastomer compositions both in the raw state (that is to say, before curing) and in the cured state (that is to say, after crosslinking or vulcanization).

The elastomer compositions according to the invention can be used to manufacture finished or semifinished articles comprising said compositions.

A third subject-matter of the present invention is thus articles comprising at least one elastomer composition as defined above, these articles consisting of footwear soles, floor coverings, gas barriers, flame-retardant materials, rollers for cableways, seals for domestic electrical appliances, seals for liquid or gas pipes, braking system seals, pipes (flexible), sheathings (in particular cable sheathings), cables, engine supports, conveyor belts, transmission belts or, preferably, tires (in particular tire treads), advantageously tires for heavy vehicles, in particular for trucks.

Finally, a fourth subject-matter of the invention is the compositions (or kits) comprising at least one reinforcing inorganic filler for an elastomer and at least one inorganic filler/elastomer coupling agent, characterized in that said reinforcing inorganic filler and said inorganic filler/elastomer coupling agent are as defined above according to the first subject-matter of the invention, that is to say that said reinforcing inorganic filler is the aluminum-comprising precipitated silica as described in the above account and said inorganic filler/elastomer coupling agent is 3-acryloxypropyltriethoxysilane.

Everything which was mentioned above in the context of the use according to the first subject-matter of the invention or in the context of the second or third subject-matter of the invention applies to these compositions (or kits) and to their uses.

In particular, these compositions can additionally comprise at least one covering agent for said precipitated silica used as reinforcing filler.

Likewise, these compositions have a particularly advantageous application in elastomer compositions comprising at least one isoprene elastomer, in particular in those comprising (for example as sole elastomer) natural rubber. A preferred application lies in their use in tires (in particular tire treads), advantageously in tires for heavy vehicles, in particular for trucks.

The following examples illustrate the invention without, however, limiting the scope thereof.

### EXAMPLES

### Example 1 (Comparative)

The following are introduced into a reactor made of stainless steel equipped with a system for stirring by propellers and with external electrical heating:
29.335 kg of water
509 g of Na₂SO₄
17.3 kg of aqueous sodium silicate, exhibiting an SiO₂/Na₂O ratio by weight equal to 3.47 and a density at 20° C. equal to 1.230.

The silicate concentration (expressed as SiO₂) in the initial vessel heel is then 76.5 g/l.

The mixture is then brought to a temperature of 83° C. while keeping it stirred. Subsequently, 17 470 g of dilute sulfuric acid with a density at 20° C. equal to 1.050 are introduced therein in order to obtain, in the reaction medium, a pH value (measured at its temperature) equal to 8. The reaction temperature is 83° C. for the first 20 minutes; it is subsequently brought from 83 to 92° C. over approximately 30 minutes, which corresponds to the end of the acidification.

Subsequently, 4120 g of aqueous sodium silicate of the type described above and 4830 g of sulfuric acid, also of the type described above, are introduced jointly into the reaction medium, this simultaneous introduction of acid and silicate being carried out so that the pH of the reaction medium, during the period of introduction, is always equal to 8.0+/−0.1. After all of this silicate has been introduced, the introduction of the dilute acid is continued for 7 minutes, so as to bring the pH of the reaction medium to a value equal to 5.2. After this introduction of acid, the reaction slurry obtained is kept stirred for 5 minutes.

The total duration of the reaction is 85 minutes.

A slurry or suspension of precipitated silica is thus obtained, which is subsequently filtered and washed using a flat filter.

The cake obtained is subsequently fluidized by mechanical and chemical action (simultaneous addition of sulfuric acid and of an amount of sodium aluminate corresponding to an Al/SiO₂ ratio by weight of 0.3%). After this disintegrating operation, the resulting slurry, with a pH equal to 6.5 and a loss on ignition equal to 85.5% (thus a solids content of 14.5% by weight), is dried by atomization.

The characteristics of the silica obtained A1 in the powder form are then as follows:

| CTAB specific surface | 163 m²/g |
|---|---|
| BET specific surface | 164 m²/g |
| aluminum content by weight | 0.26% |
| V2/V1 ratio | 51% |
| pH | 6.7 |

The silica A1 is subjected to the deagglomeration test as defined above in the description.

After deagglomeration under ultrasound, it exhibits a median diameter (Ø₅₀) of 2.9 μm.

### Example 2

The following are introduced into a reactor made of stainless steel equipped with a system for stirring by propellers and with external electrical heating:
29.335 kg of water
509 g of Na₂SO₄
17.3 kg of aqueous sodium silicate, exhibiting an SiO₂/Na₂O ratio by weight equal to 3.47 and a density at 20° C. equal to 1.230.

The silicate concentration (expressed as SiO₂) in the initial vessel heel is then 76.5 g/l. The mixture is then brought to a temperature of 83° C. while keeping it stirred. Subsequently, 18 050 g of dilute sulfuric acid with a density at 20° C. equal to 1.050 are introduced therein in order to obtain, in the reaction medium, a pH value (measured at its temperature) equal to 8. The reaction temperature is 83° C. for the first 20 minutes; it is subsequently brought from 83 to 92° C. over approximately 30 minutes, which corresponds to the end of the acidification.

Subsequently, 1850 g of aqueous sodium silicate of the type described above and 2230 g of sulfuric acid, also of the type described above, are introduced jointly into the reaction medium, this simultaneous introduction of acid and silicate being carried out so that the pH of the reaction medium, during the period of introduction, is always equal to 8.0 +/−0.1.

This stage is followed by a simultaneous addition of 4520 g of an aluminum sulfate solution with a density at 20° C. equal to 1.056 and of 2260 g of aqueous sodium silicate of the type described above, so that the pH of the reaction medium, during the period of introduction, is always equal to 8.0+/−0.1. After this joint addition, sulfuric acid of the type described above is introduced into the reaction medium over 5 minutes, so as to bring the pH of the reaction medium to a value equal to 5.2. After this introduction of acid, the reaction slurry obtained is kept stirred for 5 minutes.

The total duration of the reaction is 85 minutes.

A slurry or suspension of precipitated silica is thus obtained, which is subsequently filtered and washed using a flat filter.

The cake obtained is subsequently fluidized by mechanical and chemical action (simultaneous addition of sulfuric acid and of an amount of sodium aluminate corresponding to an Al/SiO₂ ratio by weight of 0.3%). After this disintegrating operation, the resulting slurry, with a pH equal to 6.5 and a loss on ignition equal to 86.0% (thus a solids content of 14.0% by weight), is dried by atomization.

The characteristics of the silica obtained P1 in the powder form are then as follows:

| CTAB specific surface | 161 m²/g |
|---|---|
| BET specific surface | 161 m²/g |
| aluminum content by weight | 1.2% |
| V2/V1 ratio | 45% |
| pH | 7.4 |

The silica P1 is subjected to the deagglomeration test as defined above in the description.

After deagglomeration under ultrasound, it exhibits a median diameter (Ø₅₀) of 2.5 μm.

### Example 3

The following are introduced into a reactor made of stainless steel equipped with a system for stirring by propellers and with external electrical heating:
29.335 kg of water
509 g of Na₂SO₄
17.3 kg of aqueous sodium silicate, exhibiting an SiO₂/Na₂O ratio by weight equal to 3.44 and a density at 20° C. equal to 1.232.

The silicate concentration (expressed as SiO₂) in the initial vessel heel is then 76.5 g/l.

The mixture is then brought to a temperature of 83° C. while keeping it stirred. Subsequently, 17 180 g of dilute sulfuric acid with a density at 20° C. equal to 1.050 are introduced therein in order to obtain, in the reaction medium, a pH value (measured at its temperature) equal to 8. The reaction temperature is 83° C. for the first 20 minutes; it is subsequently brought from 83 to 92° C. over approximately 30 minutes, which corresponds to the end of the acidification.

Subsequently, 4100 g of aqueous sodium silicate of the type described above and 7540 g of an aluminum sulfate solution with a density at 20° C. equal to 1.056 are introduced jointly into the reaction medium, this simultaneous introduction of aluminum sulfate (acid) and silicate being carried out so that the pH of the reaction medium, during the period of introduction, is always equal to 8.0+/−0.1. After this joint addition, sulfuric acid of the type described above is introduced into the reaction medium over 5 minutes, so as to bring the pH of the reaction medium to a value equal to 5.2. After this introduction of acid, the reaction slurry obtained is kept stirred for 5 minutes.

The total duration of the reaction is 85 minutes.

A slurry or suspension of precipitated silica is thus obtained, which is subsequently filtered and washed using a flat filter.

The cake obtained is subsequently fluidized by mechanical and chemical action (simultaneous addition of sulfuric acid and of an amount of sodium aluminate corresponding to an Al/SiO₂ ratio by weight of 0.3%). After this disintegrating operation, the resulting slurry, with a pH equal to 6.5 and a loss on ignition equal to 85.0% (thus a solids content of 15.0% by weight), is dried by atomization.

The characteristics of the silica obtained P2 in the powder form are then as follows:

| CTAB specific surface | 158 m²/g |
|---|---|
| BET specific surface | 178 m²/g |
| aluminum content by weight | 1.5% |
| V2/V1 ratio | 47% |
| pH | 7.5 |

The silica P2 is subjected to the deagglomeration test as defined above in the description.

After deagglomeration under ultrasound, it exhibits a median diameter (Ø₅₀) of 2.9 μm.

### Example 4

The following are introduced into a reactor made of stainless steel equipped with a system for stirring by propellers and with external electrical heating:
29.35 kg of water
509 g of Na₂SO₄
17.2 kg of aqueous sodium silicate, exhibiting an SiO₂/Na₂O ratio by weight equal to 3.44 and a density at 20° C. equal to 1.230.

The silicate concentration (expressed as SiO₂) in the initial vessel heel is then 76.5 g/l.

The mixture is then brought to a temperature of 83° C. while keeping it stirred. Subsequently, 16 900 g of dilute sulfuric acid with a density at 20° C. equal to 1.050 are introduced therein in order to obtain, in the reaction medium, a pH value (measured at its temperature) equal to 8. The reaction temperature is 83° C. for the first 20 minutes; it is subsequently brought from 83 to 92° C. over approximately 30 minutes, which corresponds to the end of the acidification.

Subsequently, 4100 g of aqueous sodium silicate of the type described above, 2150 g of dilute sodium aluminate with a density at 20° C. equal to 1.237 and 6000 g of sulfuric acid of the type described above are introduced jointly into the reaction medium, this simultaneous introduction of acid, silicate and sodium aluminate being carried out so that the pH of the reaction medium, during the period of introduction, is always equal to 8.0+/−0.1.

After this joint addition, the introduction into the reaction medium of sulfuric acid of the type described above is continued for 3.5 minutes, so as to bring the pH of the reaction medium to a value equal to 6.5. After this introduction of acid, the reaction slurry obtained is kept stirred for 5 minutes.

The total duration of the reaction is 87 minutes.

A slurry or suspension of precipitated silica is thus obtained, which is subsequently filtered and washed using a flat filter.

The cake obtained is subsequently fluidized by mechanical action. After this disintegrating operation, the resulting slurry, with a loss on ignition equal to 84.5% (thus a solids content of 15.5% by weight), is dried by atomization.

The characteristics of the silica obtained P3 in the powder form are then as follows:

| CTAB specific surface | 135 m²/g |
|---|---|
| BET specific surface | 160 m²/g |
| aluminum content by weight | 2.7% |
| V2/V1 ratio | 40% |
| pH | 6.7 |

The silica P3 is subjected to the deagglomeration test as defined above in the description.

After deagglomeration under ultrasound, it exhibits a median diameter (Ø₅₀) of 2.9 μm.

### Example 5

This example illustrates the use and the behavior of the aluminum-comprising precipitated silica prepared in example 3 with 3-acryloxypropyltriethoxysilane in an elastomeric composition.

Elastomeric compositions, the make up of which, expressed as parts by weight per 100 parts of elastomers (phr), is shown in table I below, are prepared in an internal mixer of Haake type.

TABLE I
Formulations used for the mixtures

| Compositions | Control 1 | Reference 1 | Composition 1 |
|---|---|---|---|
| NR (1) | 100 | 100 | 100 |
| Silica 1 (2) | 50 | 50 | — |
| Silica 2 (3) | — | — | 50 |
| Coupling agent 1 (4) | 4.0 | — | — |
| Coupling agent 2 (5) | — | 5.7 | 5.7 |
| ZnO | 3.0 | 3.0 | 3.0 |
| Stearic acid | 2.5 | 2.5 | 2.5 |
| Antioxidant 1 (6) | 1.5 | 1.5 | 1.5 |
| Antioxidant 2 (7) | 1.0 | 1.0 | 1.0 |
| Carbon black (N330) | 3.0 | 3.0 | 3.0 |
| CBS (8) | 1.5 | 1.5 | 1.5 |
| TBzTD (9) | 0.2 | 0.2 | 0.2 |
| DPG (10) | 0.5 | 0.5 | 0.5 |
| Sulfur | 1.5 | 1.8 | 1.8 |

(1) Natural rubber SMR 5 L (supplied by Safic-Alcan)
(2) Silica A1 (example 1)
(3) Silica P2 (example 3)
(4) TESPT (Z-6940 from Dow Corning)
(5) 3-acryloxypropyltriethoxysilane
(6) N-(1,3-dimethylbutyl)-N-phenyl-para-phenylenediamine (Santoflex 6-PPD from Flexsys)
(7) 2,2,4-trimethyl-1H-quinoline (Permanax TQ from Flexsys)
(8) N-cyclohexyl-2-benzothiazolesulfenamide (Rhenogran CBS-80 from RheinChemie)
(9) Tetrabenzylthiuram disulfide (Rhenogran TBzTD-70 from RheinChemie)
(10) Diphenylguanidine (Rhenogran DPG-80 from RheinChemie)
Process for the preparation of the elastomeric compositions

The process for the preparation of the compositions is carried out in two successive preparation phases. A first phase consists of a phase of high-temperature thermomechanical working. It is followed by a second phase of mechanical working at temperatures of less than 110° C.; this phase makes possible the introduction of the vulcanization system.

The first phase is carried out in an internal mixer of Haake type (capacity of 300 ml). The filling coefficient is 0.75. The initial temperature and the speed of the rotors are set on each occasion so as to achieve mixture dropping temperatures of approximately 140-160° C.

The first phase is broken down here into two passes.

It makes it possible to incorporate, in a first pass, the elastomer (natural rubber) and then the reinforcing inorganic filler consisting of the silica (fractional introduction) with the coupling agent and the stearic acid; the duration of this pass is between 4 and 10 minutes.

After cooling the mixture (temperature of less than 100° C.), a second pass makes it possible to incorporate the zinc oxide and the protecting agents/antioxidants (in particular 6-PPD); the duration of this pass is between 2 and 5 minutes.

After cooling the mixture (temperature of less than 100° C.), the second phase makes possible the introduction of the vulcanization system (sulfur and accelerators, such as CBS). It is carried out on an open mill, preheated to 50° C. The duration of this phase is between 2 and 6 minutes.

Each final mixture is subsequently calandered in the form of plaques with a thickness of 2-3 mm.

With regard to these “raw” mixtures obtained, an evaluation of their rheological properties makes it possible to optimize the vulcanization time and temperature.

Subsequently, the mechanical and dynamic properties of the optimally vulcanized mixtures are measured.

Rheological Properties

Viscosity of the Raw Mixtures

The Mooney consistency is measured on the compositions in the raw state at 100° C. using an MV 2000 rheometer according to the standard NF ISO 289.

The value of the torque, read at the end of 4 minutes after a preheating lasting one minute (Mooney Large (1+4) at 100° C.), is shown in table II.

TABLE II

| Compositions | Control 1 | Reference 1 | Composition 1 |
|---|---|---|---|
| ML(1 + 4), 100° C. | 62 | 76 | 71 |

It is found that the composition resulting from the invention (composition 1) exhibits a satisfactory raw viscosity and in particular one lower than that of the reference composition (reference 1) comprising the same coupling agent but combined with a precipitated silica exhibiting an aluminum content not in accordance with that required by the invention.

Rheometry of the Compositions

The measurements are carried out on the compositions in the raw state. The results relating to the rheology test, which is carried out at 150° C. using a Monsanto ODR rheometer according to the standard NF ISO 3417, are given in table III.

According to this test, the test composition is placed in the test chamber regulated at a temperature of 150° C. for 30 minutes, and the resistive torque opposed by the composition to a low-amplitude (3°) oscillation of a biconical rotor included in the test chamber is measured, the composition completely filling the chamber under consideration.

The following are determined from the curve of variation in the torque as a function of time:
the minimum torque (Tmin), which reflects the viscosity of the composition at the temperature under consideration;
the maximum torque (Tmax);
the delta torque (ΔT=Tmax−Tmin);
the time T98 necessary to obtain a vulcanization state corresponding to 98% of complete vulcanization (this time is taken as vulcanization optimum);
the scorch time TS2, corresponding to the time necessary in order to have a rise of 2 points above the minimum torque at the temperature under consideration (150° C.) and which reflects the time during which it is possible to process the raw mixtures at this temperature without having initiation of vulcanization (the mixture cures from TS2).

The results obtained are shown in table III.

TABLE III

| Compositions | Control 1 | Reference 1 | Composition 1 |
|---|---|---|---|
| Tmin (dN.m) | 12.8 | 13.5 | 13.0 |
| Tmax (dN.m) | 83.5 | 81.4 | 76.5 |
| Delta torque (dN.m) | 70.7 | 67.9 | 63.5 |
| TS2 (min) | 5.55 | 6.65 | 6.85 |
| T98 (min) | 10.0 | 10.3 | 9.98 |

It is found that the composition resulting from the invention (composition 1) exhibits a very satisfactory combination of rheological properties, in particular with respect to the reference composition (reference 1) comprising the same coupling agent but combined with a precipitated silica exhibiting an aluminum content not in accordance with that required by the invention.

In particular, it exhibits minimum and maximum torque values which are lower than those of the reference composition (reference 1) and similar to (Tmin), indeed even lower (Tmax) than, those of the control composition (control 1), which reflects a greater ease of processing of the mixture prepared.

In particular, composition 1 resulting from the invention (composition 1) exhibits good vulcanization kinetics (TS2, T98), in particular with respect to the reference composition (reference 1) and even with respect to the control composition (control 1), this being the case without damaging the viscosity of the raw mixture (illustrated in particular by the minimum torque).

Mechanical Properties of the Vulcanisates

The measurements are carried out on the optimally vulcanized compositions (T98) for a temperature of 150° C.

Uniaxial tensile tests are carried out in accordance with the instructions of the standard NF ISO 37 with test specimens of H2 type at a rate of 500 mm/min on an INSTRON 5564 device. The x % moduli correspond to the stress measured at x % of tensile strain and are expressed, like the tensile strength, in MPa. It is possible to determine a reinforcing index (RI) which is equal to the ratio of the modulus at 300% strain to the modulus at 100% strain.

The properties measured are collated in table IV.

TABLE IV

| Compositions | Control 1 | Reference 1 | Composition 1 |
|---|---|---|---|
| 10% Modulus (MPa) | 0.73 | 0.72 | 0.67 |
| 100% Modulus (MPa) | 3.70 | 3.80 | 3.53 |
| 300% Modulus (MPa) | 16.1 | 20.8 | 19.4 |
| Tensile strength (MPa) | 27.3 | 28.1 | 28.4 |
| RI | 4.35 | 5.47 | 5.50 |

It is found that the composition resulting from the invention (composition 1) exhibits a very good compromise in mechanical properties, at least comparable to, indeed even better than, that which is obtained with the reference composition (reference 1) or even the control composition (control 1).

Dynamic Properties of the Vulcanisates

The dynamic properties are measured on a viscosity analyser (Metravib VA3000) according to the standard ASTM D5992.

In a first series of measurements, the values for loss factor (tan δ) and compressive dynamic complex modulus (E*) are recorded on vulcanized samples (cylindrical test specimen with a cross section of 95 mm² and a height of 14 mm). The sample is subjected at the start to a 10% prestrain and then to a sinusoidal strain in alternating compression of +/−2%. The measurements are carried out at 60° C. and at a frequency of 10 Hz.

The results, presented in table V, are the compressive complex modulus (E*, 60° C., 10 Hz) and the loss factor (tan δ, 60° C., 10 Hz).

In a second series of measurements, the values for the loss factor (tan δ) and dynamic shear elastic modulus (G′) are recorded on vulcanized samples (parallelepipedal test specimen with a cross section of 8 mm² and a height of 7 mm). The sample is subjected to a double alternating sinusoidal shear strain at a temperature of 40° C. and at a frequency of 10 Hz. The strain amplitude sweeping process is carried out according to an outward-return cycle, proceeding outward from 0.1 to 50% and then returning from 50 to 0.1%.

The results, presented in table V, result from the return strain amplitude sweep and relate to the maximum value of the loss factor (tan δ max return, 40° C., 10 Hz) and to the amplitude of the elastic modulus (ΔG', 40° C., 10 Hz) between the values at 0.1% and 50% strain (Payne effect).

TABLE V

| Compositions | Control 1 | Reference 1 | Composition 1 |
|---|---|---|---|
| E*, 60° C., 10 Hz (MPa) | 6.24 | 6.33 | 5.81 |
| Tan δ, 60° C., 10 Hz | 0.056 | 0.047 | 0.054 |
| ΔG′, 60° C., 10 Hz (MPa) | 1.76 | 1.03 | 0.71 |
| Tan δ max return, | 0.100 | 0.074 | 0.067 |
| 60° C., 10 Hz | | | |

The composition resulting from the invention (composition 1) exhibits very good dynamic properties (hysteresis properties at 60° C.), in particular with respect to the reference composition (reference 1) and also with respect to the control composition (control 1).

It is found, on reading the results from tables II to V, that the composition resulting from the invention (composition 1) exhibits a very good compromise in properties.

### Example 6

This example illustrates the use and the behavior of the aluminum-comprising precipitated silica prepared in example 2 with 3-acryloxypropyltriethoxysilane in an elastomeric composition.

Elastomeric compositions, the make up of which, expressed as parts by weight per 100 parts of elastomers (phr), is shown in table VI below, are prepared in an internal mixer of Haake type.

TABLE VI
Formulations used for the mixtures

| Compositions | Control 2 | Reference 2 | Composition 2 |
|---|---|---|---|
| NR (1) | 100 | 100 | 100 |
| Silica 1 (2) | — | 50 | — |
| Silica 2 (3) | 50 | — | 50 |
| Coupling agent 1 (4) | 4.0 | — | — |
| Coupling agent 2 (5) | — | 5.7 | 5.7 |
| ZnO | 3.0 | 3.0 | 3.0 |
| Stearic acid | 2.5 | 2.5 | 2.5 |
| Antioxidant 1 (6) | 1.5 | 1.5 | 1.5 |
| Antioxidant 2 (7) | 1.0 | 1.0 | 1.0 |
| Carbon black (N330) | 3.0 | 3.0 | 3.0 |
| CBS (8) | 1.5 | 1.5 | 1.5 |
| TBzTD (9) | 0.2 | 0.2 | 0.2 |
| DPG (10) | 1.5 | 1.5 | 1.5 |
| Sulfur | 0.5 | 0.5 | 0.5 |

(1) Natural rubber SMR - CV60 (supplied by Safic-Alcan)
(2) Silica A1 (example 1)
(3) Silica P1 (example 2)
(4) TESPT (Z-6940 from Dow Corning)
(5) 3-acryloxypropyltriethoxysilane
(6) N-(1,3-dimethylbutyl)-N-phenyl-para-phenylenediamine (Santoflex 6-PPD from Flexsys)
(7) 2,2,4-trimethyl-1H-quinoline (Permanax TQ from Flexsys)
(8) N-cyclohexyl-2-benzothiazolesulfenamide (Rhenogran CBS-80 from RheinChemie)
(9) Tetrabenzylthiuram disulfide (Rhenogran TBzTD-70 from RheinChemie)
(10) Diphenylguanidine (Rhenogran DPG-80 from RheinChemie)
Process for the preparation of the elastomeric compositions

The process for the preparation of the compositions is carried out in two successive preparation phases. A first phase consists of a phase of high-temperature thermomechanical working. It is followed by a second phase of mechanical working at temperatures of less than 110° C.; this phase makes possible the introduction of the vulcanization system.

The first phase is carried out in an internal mixer of Haake type (capacity of 300 ml). The filling coefficient is 0.75. The initial temperature and the speed of the rotors are set on each occasion so as to achieve mixture dropping temperatures of approximately 140-160° C.

The first phase is broken down here into two passes.

It makes it possible to incorporate, in a first pass, the elastomer (natural rubber) and then the reinforcing inorganic filler consisting of the silica (fractional introduction) with the coupling agent and the stearic acid; the duration of this pass is between 4 and 10 minutes. After cooling the mixture (temperature of less than 100° C.), a second phase makes it possible to incorporate the zinc oxide and the protecting agents/antioxidants (in particular 6-PPD); the duration of this pass is between 2 and 5 minutes.

After cooling the mixture (temperature of less than 100° C.), the second phase makes possible the introduction of the vulcanization system (sulfur and accelerators, such as CBS). It is carried out on an open mill, preheated to 50° C. The duration of this phase is between 2 and 6 minutes.

Each final mixture is subsequently calandered in the form of plaques with a thickness of 2-3 mm.

With regard to these “raw” mixtures obtained, an evaluation of their rheological properties makes it possible to optimize the vulcanization time and temperature.

Subsequently, the mechanical and dynamic properties of the optimally vulcanized mixtures are measured.

Rheological Properties

Viscosity of the Raw Mixtures

The Mooney consistency is measured as in example 5.

The value of the torque, read at the end of 4 minutes after a preheating lasting one minute (Mooney Large (1+4) at 100° C.), is shown in table VII.

TABLE VII

| Compositions | Control 2 | Reference 2 | Composition 2 |
|---|---|---|---|
| ML(1 + 4), 100° C. | 56 | 53 | 50 |

It is found that the composition resulting from the invention (composition 2) exhibits a very satisfactory raw viscosity, lower than that of the reference composition (reference 2) comprising the same coupling agent but combined with a precipitated silica exhibiting an aluminum content not in accordance with that required by the invention, or than that of the control composition (control 2) comprising the same precipitated silica but combined with another coupling agent.

Rheometry of the Compositions

The measurements are carried out as in example 5.

The results obtained are shown in table VIII.

TABLE VIII

| Compositions | Control 2 | Reference 2 | Composition 2 |
|---|---|---|---|
| Tmin (dN.m) | 13.0 | 11.2 | 10.8 |
| Tmax (dN.m) | 70.1 | 75.9 | 72.8 |
| Delta torque (dN.m) | 57.1 | 64.7 | 62.0 |
| TS2 (min) | 5.68 | 7.10 | 7.77 |

It is found that the composition resulting from the invention (composition 1) exhibits a very satisfactory combination of rheological properties, in particular with respect to the reference composition (reference 2) comprising the same coupling agent but combined with a precipitated silica exhibiting an aluminum content not in accordance with that required by the invention.

In particular, it exhibits minimum and maximum torque values which are lower than those of the reference composition (reference 2), indeed even lower (Tmin) than those of the control composition (control 2), which reflects a great ease of processing of the mixture prepared.

The composition resulting from the invention (composition 2) exhibits good vulcanization kinetics (TS2), in particular with respect to the reference composition (reference 2) and with respect to the control composition (control 2), this being the case without damaging the viscosity of the raw mixture (illustrated in particular by the minimum torque).

Mechanical Properties of the Vulcanisates

The measurements are carried out on optimally vulcanized compositions (that is to say, at a vulcanization state corresponding to 98% of complete vulcanization) for a temperature of 150° C.

Uniaxial tensile tests are carried out in accordance with the instructions of the standard NF ISO 37 with test specimens of H2 type at a rate of 500 mm/min on an INSTRON 5564 device. The x % moduli correspond to the stress measured at x % of tensile strain and are expressed, like the tensile strength, in MPa. It is possible to determine a reinforcing index (RI) which is equal to the ratio of the modulus at 300% strain to the modulus at 100% strain.

The properties measured are collated in table IX.

TABLE IX

| Compositions | Control 2 | Reference 2 | Composition 2 |
|---|---|---|---|
| 10% Modulus (MPa) | 0.58 | 0.64 | 0.56 |
| 100% Modulus (MPa) | 2.83 | 3.18 | 2.55 |
| 300% Modulus (MPa) | 13.7 | 18.7 | 15.3 |
| Tensile strength (MPa) | 28.7 | 28.8 | 29.3 |
| RI | 4.85 | 5.88 | 5.99 |

It is found that the composition resulting from the invention (composition 2) exhibits a very good compromise in mechanical properties, at least comparable to, indeed even better than, that which is obtained with the reference composition (reference 2) or the control composition (control 2).

Dynamic Properties of the Vulcanisates

The dynamic properties are measurd as in example 5.

The results are presented in table X.

TABLE X

| Compositions | Control 2 | Reference 2 | Composition 2 |
|---|---|---|---|
| E*, 60° C., 10 Hz (MPa) | 5.76 | 5.38 | 5.06 |
| Tan δ, 60° C., 10 Hz | 0.077 | 0.054 | 0.054 |

The composition resulting from the invention (composition 2) exhibits very good dynamic properties (hysteresis properties at 60° C.), in particular with respect to the reference composition (reference 2) and to the control composition (control 2).

It is found, on reading the results from tables VII to X, that the composition resulting from the invention (composition 2) exhibits a very good compromise in properties.

### Example 7

This example illustrates the use and the behavior of a precipitated silica S, comprising more than 0.5% by weight of aluminum and exhibiting the characteristics below, and 3-acryloxypropyltriethoxysilane in an elastomeric composition.

1—The precipitated silica S exhibits the characteristics below:

| CTAB specific surface | 160 m²/g |
|---|---|
| BET specific surface | 164 m²/g |
| aluminum content by weight | 1.6% |
| V2/V1 ratio | 56% |

It is subjected to the deagglomeration test as defined above in the description.

After deagglomeration under ultrasound, it exhibits a median diameter (Ø₅₀) of 3.1 μm and an ultrasound deagglomeration factor (F_{D}) of 9.4 ml.

2—Elastomeric compositions, the make up of which, expressed as parts by weight per 100 parts of elastomers (phr), is shown in table I below, are prepared in an internal mixer of Haake type.

TABLE I
Formulations used for the mixtures

| Compositions | Control 3 | Composition 3 |
|---|---|---|
| NR (1) | 100 | 100 |
| Silica 1 (2) | 50 | 50 |
| Coupling agent 1 (3) | 4.0 | — |
| Coupling agent 2 (4) | — | 4.5 |
| ZnO | 3.0 | 3.0 |
| Stearic acid | 2.5 | 2.5 |
| Antioxidant 1 (5) | 1.5 | 1.5 |
| Antioxidant 2 (6) | 1.0 | 1.0 |
| Carbon black (N330) | 3.0 | 3.0 |
| CBS (7) | 1.5 | 1.5 |
| DPG (8) | 0.5 | 0.5 |
| Sulfur | 1.5 | 2.0 |

(1) Natural rubber SMR 5 - CV60 (supplied by Safic-Alcan)
(2) Silica S
(3) TESPT (Z-6940 from Dow Corning)
(4) 3-acryloxypropyltriethoxysilane
(5) N-(1,3-dimethylbutyl)-N-phenyl-para-phenylenediamine (Santoflex 6-PPD from Flexsys)
(6) 2,2,4-trimethyl-1H-quinoline (Permanax TQ from Flexsys)
(7) N-cyclohexyl-2-benzothiazolesulfenamide (Rhenogran CBS-80 from RheinChemie)
(8) Diphenylguanidine (Rhenogran DPG-80 from RheinChemie)

Process for the Preparation of the Elastomeric Compositions

The process for the preparation of the compositions is carried out in two successive preparation phases. A first phase consists of a phase of high-temperature thermomechanical working. It is followed by a second phase of mechanical working at temperatures of less than 110° C.; this phase makes possible the introduction of the vulcanization system.

The first phase is carried out in an internal mixer of Haake type (capacity of 300 ml). The filling coefficient is 0.75. The initial temperature and the speed of the rotors are set on each occasion so as to achieve mixture dropping temperatures of approximately 150-170° C.

The first phase is broken down here into two passes.

It makes it possible to incorporate, in a first pass, the elastomer (natural rubber) and then the reinforcing inorganic filler consisting of the silica (fractional introduction) with the coupling agent and the stearic acid; the duration of this pass is between 4 and 10 minutes.

After cooling the mixture (temperature of less than 100° C.), a second pass makes it possible to incorporate the zinc oxide and the protecting agents/antioxidants (in particular 6-PPD); the duration of this pass is between 2 and 5 minutes.

After cooling the mixture (temperature of less than 100° C.), the second phase makes possible the introduction of the vulcanization system (sulfur and accelerators, such as CBS). It is carried out on an open mill, preheated to 50° C. The duration of this phase is between 2 and 6 minutes.

Each final mixture is subsequently calandered in the form of plaques with a thickness of 2-3 mm.

With regard to these “raw” mixtures obtained, an evaluation of their rheological properties makes it possible to optimize the vulcanization time and temperature.

Subsequently, the mechanical and dynamic properties of the optimally vulcanized mixtures are measured.

Rheological Properties

Viscosity of the Raw Mixtures

The Mooney consistency is measured on the compositions in the raw state at 100° C. using an MV 2000 rheometer according to the standard NF ISO 289.

The value of the torque, read at the end of 4 minutes after a preheating lasting one minute (Mooney Large (1+4) at 100° C.), is shown in table II.

Rheometry of the Compositions

The measurements are carried out on the compositions in the raw state. The results relating to the rheology test, which is carried out at 150° C. using a Monsanto ODR rheometer according to the standard NF ISO 3417, are given in table III.

According to this test, the test composition is placed in the test chamber regulated at a temperature of 150° C. for 30 minutes, and the resistive torque opposed by the composition to a low-amplitude)(3° oscillation of a biconical rotor included in the test chamber is measured, the composition completely filling the chamber under consideration.

The following are determined from the curve of variation in the torque as a function of time:
the minimum torque (Tmin), which reflects the viscosity of the composition at the temperature under consideration;
the scorch time TS2, corresponding to the time necessary in order to have a rise of 2 points above the minimum torque at the temperature under consideration (150° C.) and which reflects the time during which it is possible to process the raw mixtures at this temperature without having initiation of vulcanization (the mixture cures from TS2).

The results obtained are shown in table II.

TABLE II

| Compositions | Control 3 | Composition 3 |
|---|---|---|
| ML(1 + 4), 100° C. | 55 | 53 |
| Tmin (dN.m) | 11.9 | 12.0 |
| TS2 (min) | 5.8 | 7.1 |

The composition resulting from the invention (composition 3) results in rather low values for Mooney consistency and minimum torque.

Thus, it is found that the composition resulting from the invention exhibits a satisfactory raw viscosity (Mooney consistency), lower than that of the control composition (control 3).

It is also found that this composition in accordance with the invention has satisfactory rheological properties. It exhibits good vulcanization kinetics (TS2), in particular with respect to the control composition, without damaging the viscosity of the raw mixture (illustrated by the minimum torque).

Mechanical Properties of the Vulcanisates

The measurements are carried out on optimally vulcanized compositions (that is to say, at a vulcanization state corresponding to 98% of complete vulcanization) for a temperature of 150° C.

Uniaxial tensile tests are carried out in accordance with the instructions of the standard NF ISO 37 with test specimens of H2 type at a rate of 500 mm/min on an INSTRON 5564 device. The x % moduli correspond to the stress measured at x % of tensile strain and are expressed, like the tensile strength, in MPa. It is possible to determine a reinforcing index (RI) which is equal to the ratio of the modulus at 300% strain to the modulus at 100% strain.

The measurement of loss in weight by abrasion is carried out according to the instructions of the standard NF ISO 4649, using a Zwick abrasion tester, where the cylindrical test specimen is subjected to the action of an abrasive cloth having P60 grains which is attached to the surface of a rotating drum under a contact pressure of 10N and for a displacement of 40 m. The value measured is a volume of loss of substance (in mm³) after wear by abrasion; the lower it is, the better the abrasion resistance.

The properties measured are collated in table III.

TABLE III

| Compositions | Control 3 | Composition 3 |
|---|---|---|
| 10% Modulus (MPa) | 0.63 | 0.55 |
| 100% Modulus (MPa) | 2.8 | 2.7 |
| 300% Modulus (MPa) | 12.6 | 15.7 |
| Tensile strength (MPa) | 26.2 | 26.8 |
| RI | 4.5 | 5.8 |
| Loss by abrasion (mm³) | 118 | 95 |

It is found that the composition resulting from the invention (composition 3) exhibits a very good compromise in mechanical properties, in particular with respect to what is obtained with the control composition (control 3).

The composition resulting from the invention thus exhibits relatively low 10% and 100% moduli and a high 300% modulus, hence a greater reinforcing index.

In addition, this composition 3 exhibits, in addition to a satisfactory tensile strength, a lower loss by abrasion, that is to say a better resistance to abrasion, resulting in an increase in wear resistance, which is important in a tire application, in particular for heavy-duty vehicles.

Dynamic Properties of the Vulcanisates

The dynamic properties are measured on a viscosity analyser (Metravib VA3000) according to the standard ASTM D5992.

In a first series of measurements, the values for loss factor (tan δ) and compressive dynamic complex modulus (E*) are recorded on vulcanized samples (cylindrical test specimen with a cross section of 95 mm² and a height of 14 mm). The sample is subjected at the start to a 10% prestrain and then to a sinusoidal strain in alternating compression of +/−2%. The measurements are carried out at 60° C. and at a frequency of 10 Hz.

The results, presented in table IV, are the compressive complex modulus (E*, 60° C., 10 Hz) and the loss factor (tan δ, 60° C., 10 Hz).

In a second series of measurements, the values for the loss factor (tan δ) and dynamic shear elastic modulus (G′) are recorded on vulcanized samples (parallelepipedal test specimen with a cross section of 8 mm² and a height of 7 mm). The sample is subjected to a double alternating sinusoidal shear strain at a temperature of 40° C. and at a frequency of 10 Hz. The strain amplitude sweeping process is carried out according to an outward-return cycle, proceeding outward from 0.1 to 50% and then returning from 50 to 0.1%.

The results, presented in table IV, result from the return strain amplitude sweep and relate to the maximum value of the loss factor (tan δ max return, 40° C., 10 Hz) and to the amplitude of the elastic modulus (ΔG′, 40° C., 10 Hz) between the values at 0.1% and 50% strain (Payne effect).

TABLE IV

| Compositions | Control 3 | Composition 3 |
|---|---|---|
| E*, 60° C., 10 Hz (MPa) | 6.93 | 5.64 |
| Tan δ, 60° C., 10 Hz | 0.094 | 0.076 |
| ΔG′, 60° C., 10 Hz (MPa) | 2.04 | 1.07 |
| Tan δ max return - | 0.130 | 0.092 |
| 60° C., 10 Hz | | |

The composition resulting from the invention (composition 3) exhibits very good dynamic properties (hysteresis properties at 60° C.), in particular with respect to the control composition (control 3).

It is found, on reading the results from tables II to IV, that the composition resulting from the invention (composition 3) exhibits a very good compromise in properties.

1. A method of making an elastomer composition, the method comprising making the composition with at least one isoprene elastomer compring:
an aluminum-comprising precipitated silica as a reinforcing inorganic filler, the aluminum content of the precipitated silica being greater than 0.5% by weight, with
3-acryloxypropyltriethoxysilane as an inorganic filler/elastomer coupling agent.

2. The method as described by claim 1, wherein the precipitated silica has an aluminum content of at most 7.0% by weight.

3. The method as described by claim 1, wherein the precipitated silica has an aluminum content of from 0.75% to 4.0% by weight.

4. The method as described by claim 1, wherein the precipitated silica is highly dispersible.

5. The method as described by claim 1, wherein the precipitated silica has:
a CTAB specific surface of from 70 m²/g to 240 m²/g, and
a BET specific surface of from 70 m²/g to 240 m²/g.

6. The method as described by claim 1, wherein the precipitated silica has a median diameter (Ø₅₀), after deagglomeration under ultrasound, of less than 5 μm.

7. The method as described by claim 1, wherein the precipitated silica has an ultrasound deagglomeration factor (F_{D}) of greater than 4.5 ml.

8. The method as described by claim 1, wherein the precipitated silica has a DOP oil uptake of less than 300 ml/100 g.

9. The method as described by claim 1, wherein the precipitated silica is obtained by a process comprising conducting a precipitation reaction between a silicate and an acidifying agent, whereby a suspension of precipitated silica is obtained, and then separating and drying of this suspension, in which:
the precipitation reaction is carried out in the following way:
(i) forming an initial vessel heel comprising a silicate and an electrolyte wherein a concentration of silicate (expressed as SiO₂) in the initial vessel heel is less than 100 g/l and a concentration of electrolyte in the initial vessel heel is less than 17 g/l,
(ii) adding an acidifying agent to the vessel heel until the reaction medium has a pH value of at least 7,
(iii) simultaneously adding acidifying agent and a silicate to the reaction medium,
drying a suspension exhibiting a solids content of at most 24% by weight, the process comprising one of the three following operations (a), (b) or (c):
(a) adding at least one aluminum compound and subsequently or simultaneously adding, a basic agent to the reaction medium, after stage (iii),
(b) simultaneously adding a silicate and at least one aluminum compound to the reaction medium, after stage (iii) or in place of stage (iii),
(c) conducting stage (iii) by simultaneously adding, to the reaction medium, acidifying agent, a silicate and at least one aluminum compound.

10. The method as described by claim 1, wherein the amount of 3-acryloxypropyltriethoxysilane used is from 1% to 20%, with respect to the amount of the precipitated silica used.

11. The method as described by claim 1, further comprising premixing the precipitated silica and the 3-acryloxypropyltriethoxysilane with one another.

12. The method as described by claim 1, wherein the elastomer composition further comprises at least one covering agent for the precipitated silica, optionally premixed with the precipitated silica and the 3-acryloxypropyltriethoxysilane.

13. The method as described by claim 1, wherein the elastomer composition does not comprise another inorganic filler/elastomer coupling agent.

14. The method as described by claim 1, wherein there is an absence of free radical initiator.

15. The method as described by claim 1, wherein the elastomer composition does not comprise elastomers other than the isoprene elastomer(s).

16. The method as described by claim 1, wherein the elastomer composition comprises at least one isoprene elastomer and at least one diene elastomer other than an isoprene elastomer.

17. The method as described by claim 1, wherein the elastomer composition comprises at least one isoprene elastomer selected from the group consisiting of:
(1) a synthetic polyisoprene obtained by homopolymerization of isoprene or 2-methyl-1,3-butadiene;
(2) a synthetic polyisoprene obtained by copolymerization of isoprene with one or more ethylenically unsaturated monomers selected from the group consisting of:
(2.1) a conjugated diene monomer, other than isoprene, having from 4 to 22 carbon atoms;
(2.2) a vinylaromatic monomer having from 8 to 20 carbon atoms;
(2.3) a vinyl nitrile monomer having from 3 to 12 carbon atoms;
(2.4) an acrylic ester monomer derived from acrylic acid or methacrylic acid with alkanols having from 1 to 12 carbon atoms;
(2.5) a mixture of at least two of the abovementioned monomers (2.1) to (2.4); copolymeric polyisoprenes comprising from 20% to 99% by weight of isoprene units and from 80% to 1% by weight of diene, vinylaromatic, vinyl nitrile and/or acrylic ester units;
(3) natural rubber;
(4) a copolymer obtained by copolymerization of isobutene and isoprene, and also halogenated versions of these copolymers;
(5) a mixture of at least two of the abovementioned elastomers (1) to (4); and
(6) a mixture comprising more than 50% by weight of abovementioned elastomer (1) or (3) and less than 50% by weight of one or more diene elastomers other than isoprene elastomers.

18. The method as described by claim 17, wherein the elastomer composition comprises at least one isoprene elastomer selected from the group consisiting of:
(1) a homopolymeric synthetic polyisoprene;
(2) a copolymeric synthetic polyisoprene comprised of poly(isoprene/butadiene), poly(isoprene/styrene) and poly(isoprene/butadiene/styrene);
(3) natural rubber;
(4) butyl rubber;
(5) a mixture of at least two of the abovementioned elastomers (1) to (4); and
(6) a mixture comprising more than 50% by weight of abovementioned elastomer (1) or (3) and less than 50% by weight of diene elastomer other than an isoprene elastomer comprised of polybutadiene, polychloroprene, poly(butadiene/styrene), poly(butadiene/acrylonitrile) or a terpolymer.

19. The method as described by claim 1, wherein the elastomer composition comprises, as isoprene elastomer, at least natural rubber, the elastomer composition optionally comprising, as elastomer(s), solely natural rubber.

20. The method as described by claim 1, wherein the elastomer composition additionally comprises at least one compound selected from the group consisting of a vulcanization agent, a vulcanization accelerator, a vulcanization activator, a carbon black, a protecting agent and a plasticizing agent.

21. The method as described by claim 1, wherein the elastomer composition is used in a sole of footwear, a floor covering, a gas barrier, a flame-retardant material, a roller for a cableway, a seal for a domestic electrical appliance, a seal for a liquid or gas pipe, a braking system seal, a pipe, a sheathing, a cable, an engine support, a conveyor belt, a transmission belt, or in a tire.

22. The method as described by claim 21, wherein the elastomer composition is used in production of a tire for a heavy vehicle.

23. An elastomer composition comprising:
at least one isoprene elastomer,
at least one reinforcing inorganic filler, and
at least one inorganic filler/elastomer coupling agent, wherein the said inorganic filler/elastomer coupling agent is 3-acryloxypropyltriethoxysilane, the reinforcing inorganic filler and the inorganic filler/elastomer coupling agent is as described by claim 1.

24. The composition as described by claim 23, wherein the amount of 3-acryloxypropyltriethoxysilane is from 1% to 20%, with respect to the amount of the precipitated silica.

25. The composition as described by claim 24, wherein the precipitated silica and the 3-acryloxypropyltriethoxysilane are premixed with one another.

26. The composition as described by claim 24, wherein the said composition further comprises at least one covering agent for the precipitated silica, optionally premixed with the precipitated silica and the 3-acryloxypropyltriethoxysilane.

27. The composition as described by claim 23, wherein the composition does not comprise another inorganic filler/elastomer coupling agent.

28. The composition as described by claim 23, wherein the composition does not comprise a free radical initiator.

29. The composition as described by claim 23, wherein the composition does not comprise elastomers other than said isoprene elastomer(s).

30. The composition as described by claim 23, wherein the composition comprises at least one isoprene elastomer and at least one diene elastomer other than an isoprene elastomer.

31. The composition as described by claim 23, wherein the composition comprises at least one isoprene elastomer selected from:
(1) a synthetic polyisoprene obtained by homopolymerization of isoprene or 2-methyl-1,3-butadiene;
(2) a synthetic polyisoprene obtained by copolymerization of isoprene with one or more ethylenically unsaturated monomers selected from the group consisting of:
(2.1) a conjugated diene monomer, other than isoprene, having from 4 to 22 carbon atoms;
(2.2) a vinylaromatic monomer having from 8 to 20 carbon atoms;
(2.3) a vinyl nitrile monomer having from 3 to 12 carbon atoms;
(2.4) an acrylic ester monomer derived from acrylic acid or methacrylic acid with alkanols having from 1 to 12 carbon atoms;
(2.5) a mixture of at least two of the abovementioned monomers (2.1) to (2.4); copolymeric polyisoprenes comprising from 20% to 99% by weight of isoprene units and from 80% to 1% by weight of diene, vinylaromatic, vinyl nitrile and/or acrylic ester units;
(3) natural rubber;
(4) a copolymer obtained by copolymerization of isobutene and isoprene, and also halogenated versions of these copolymers;
(5) a mixture of at least two of the abovementioned elastomers (1) to (4); and
(6) a mixture comprising more than 50% by weight of abovementioned elastomer (1) or (3) and less than 50% by weight of one or more diene elastomers other than isoprene elastomers.

32. The composition as described by claim 31, wherein the composition comprises at least one isoprene elastomer selected from the group consisting of:
(1) a homopolymeric synthetic polyisoprene;
(2) a copolymeric synthetic polyisoprene comprised of poly(isoprene/butadiene), poly(isoprene/styrene) and poly(isoprene/butadiene/styrene);
(3) natural rubber;
(4) butyl rubber;
(5) a mixture of at least two of the abovementioned elastomers (1) to (4);
(6) a mixture comprising more than 50% by weight of abovementioned elastomer (1) or (3) and less than 50% by weight of diene elastomer other than an isoprene elastomer comprised of polybutadiene, polychloroprene, poly(butadiene/styrene), poly(butadiene/acrylonitrile) or a terpolymer.

33. The composition as described by claim 23, wherein the composition comprises, an isoprene elastomer, at least natural rubber, the elastomer composition optionally comprising, as elastomer(s), solely natural rubber.

34. The composition as described by claim 23, wherein the composition further comprises at least one compound selected from the group consisting of a vulcanization agent, a vulcanization accelerator, a vulcanization activator, a carbon black, a protecting agent, an antireversion agent and a plasticizing agent.

35. An article comprising at least one composition as described by claim 23, wherein the article is a footwear sole, a floor covering, a gas barrier, a flame-retardant material, a roller for a cableway, a seal for a domestic electrical appliance, a seal for a liquid or gas pipe, a braking system seal, a pipe, a sheathing, a cable, an engine support, a conveyor belt, a transmission belt, and a tire.

36. The tire as described by claim 35, wherein the tire is designed for use in a heavy vehicle.

37. A composition comprising at least one reinforcing inorganic filler for an elastomer and at least one inorganic filler/elastomer coupling agent, wherein the inorganic filler/elastomer coupling agent is 3-acryloxypropyltriethoxysilane, the reinforcing inorganic filler and said inorganic filler/elastomer coupling agent is as described by claim 1.

38. The composition as described by claim 37, wherein the composition further comprises at least one covering agent for the reinforcing inorganic filler.

39. The composition as described by claim 37, wherein the elastomer composition comprises at least one isoprene elastomer.

40. The composition as described by claim 39, wherein the composition is designed for use in the production of a tire.

41. The method as described by claim 2, wherein the aluminum content is at most 5.0% by weight.

42. The method as described by claim 2, wherein the aluminum content is at most 3.5% by weight.

43. The method as described by claim 3, wherein the aluminum content is from 0.8% to 3.5% by weight.

44. The method as described by claim 3, wherein the aluminum content is from 0.9% to 3.2% by weight.

45. The method as described by claim 6, wherein the median diameter is less the 4 μm.

46. The method as described by claim 6, wherein the median diameter is less than 3 μm.

47. The method as described by claim 7, wherein the ultrasound deaggloneration factor (F_{D}) of greater than 10 ml.

48. The method as described by claim 10, wherein the amount of 3-acryloyloxypropyltriethoxysilane used is from 2% to 15%.

49. The method as described by claim 16, wherein the amount of isoprene elastomer(s) with respect to the total amount of elastomer(s) is greater than 50% by weight.

50. The composition of claim 24, wherein the amount of 3-acryloyloxypropyltriethoxysilane used is from 2% to 15% with respect to the amount of the precipated silica.

51. The composition as described by claim 30, wherein the amount of isoprene elastomer(s) with respect to the total amount of elastomer(s) is greater than 50% by weight.

52. The composition as described by claim 39, wherein the at least one isoprene elastomer is natural rubber.
